(19) United States
(12) Patent Application Publication
(10) Pub. No.: US 2024/0374363 A1
(43) Pub. Date: Nov. 14, 2024

(54) ELECTRIC TOOTHBRUSH

(71) Applicant: Murata Manufacturing Co., Ltd., Kyoto (JP)

(72) Inventor: Shinji OKAWA, Kyoto (JP)

(21) Appl. No.: 18/782,459

(22) Filed: Jul. 24, 2024

Related U.S. Application Data
(63) Continuation of application No. PCT/JP2023/002860, filed on Jan. 30, 2023.

(30) Foreign Application Priority Data
Feb. 1, 2022 (JP) 2022-014326

(51) Int. Cl. A61C 17/22; A46B 13/02; A46B 15/00; A61C 17/20

(52) U.S. Cl. CPC A61C 17/221; A46B 13/023; A46B 15/0006; A61C 17/20; A61C 17/225

(57) ABSTRACT

A control unit causes a first vibration body to generate a first force sense in a first direction by controlling a vibration pattern of the first vibration body. The control unit causes a second vibration body to generate a second force sense in a second direction by controlling a vibration pattern of the second vibration body. The control unit executes guide processing for controlling one or more selected from the first direction and the second direction, in response to a posture of a handle which is detected by a posture sensor.

### CROSS REFERENCE TO RELATED APPLICATION

This is a continuation of International Application No. PCT/JP2023/002860 filed on Jan. 30, 2023 which claims priority from Japanese Patent Application No. 2022-014326 filed on Feb. 1, 2022. The contents of these applications are incorporated herein by reference in their entireties.

### BACKGROUND ART

### Technical Field

The present disclosure relates to an electric toothbrush.

An electric toothbrush described in Patent Document 1 includes a handle, a head having a brush, and a driving body that drives the brush. The handle has a substantially cylindrical shape. For example, the handle is used by a user gripping the handle with fingers. The driving body is located inside the handle. The head is connected to an end of the handle. When the brush is driven by the driving body in a state where the brush is in contact with teeth, the teeth are brushed.
Patent Document 1: Japanese Unexamined Patent Application Publication No. 2018-192036

### BRIEF SUMMARY

In the electric toothbrush as in Patent Document 1, there must be an ideal moving method to efficiently brush the teeth. However, the moving method for the electric toothbrush depends on a choice of the user. Therefore, the electric toothbrush cannot guide the user to adopt the moving method.

According to an aspect of the present disclosure, in order to solve the above-described problems, there is provided an electric toothbrush including a handle to be gripped by a user with fingers, a first vibration body located inside the handle, a second vibration body located inside the handle, a head coupled to the handle and having a brush, a driving body that drives the brush, a control unit that causes the first vibration body to generate a first force sense in a first direction by controlling a vibration pattern of the first vibration body and that causes the second vibration body to generate a second force sense in a second direction by controlling a vibration pattern of the second vibration body, and a posture sensor that detects a posture of the handle. The control unit executes guide processing for controlling one or more selected from the first direction and the second direction, in response to the posture of the handle which is detected by the posture sensor.

According to the above-described configuration, the guide processing can present a force sense to the user such that the posture of the handle is guided to a suitable posture. That is, the electric toothbrush can guide the user who uses the electric toothbrush to adopt a suitable moving method.

According to another aspect of the present disclosure, in order to solve the above-described problems, there is provided an electric toothbrush including a handle to be gripped by a user with fingers, a first vibration body located inside the handle, a second vibration body located inside the handle, a head coupled to the handle and having a brush, a driving body that drives the brush, a control unit that causes the first vibration body to generate a first force sense in a first direction by controlling a vibration pattern of the first vibration body and that causes the second vibration body to generate a second force sense in a second direction by controlling a vibration pattern of the second vibration body, and a position sensor that detects a position of the brush. The control unit executes guide processing for controlling one or more selected from the first direction and the second direction, in response to the position of the brush which is detected by the position sensor.

According to the above-described configuration, the guide processing can present a force sense to the user such that the position of the brush is guided to a suitable position. That is, the electric toothbrush can guide the user who uses the electric toothbrush to adopt a suitable moving method.

According to still another aspect of the present disclosure, in order to solve the above-described problems, there is provided an electric toothbrush including a handle to be gripped by a user with fingers, a first vibration body located inside the handle, a second vibration body located inside the handle, a head coupled to the handle and having a brush, a driving body that drives the brush, and a control unit that causes the first vibration body to generate a first force sense in a first direction by controlling a vibration pattern of the first vibration body and that causes the second vibration body to generate a second force sense in a second direction by controlling a vibration pattern of the second vibration body. The control unit has a storage unit that stores a predetermined order for changing one or more selected from the first direction and the second direction. The control unit executes guide processing for changing, in the order, one or more selected from the first direction and the second direction.

According to the above-described configuration, the guide processing can present a force sense to the user such that a suitable change in the posture of the handle is reproduced. That is, the user can reproduce a suitable moving method of the electric toothbrush by changing the posture of the handle in accordance with the force sense presented by the electric toothbrush.

Since the force sense is presented to the user, the moving method for the electric toothbrush can be guided to the user.

### BRIEF DESCRIPTION OF THE DRAWINGS

FIG. 1 is a schematic view illustrating an electric toothbrush according to an embodiment.

FIG. 2 is a view for describing a use state during guide processing according to the embodiment.

FIG. 3 is a view for describing a use state during the guide processing according to the embodiment.

FIG. 4 is a view for describing a use state during the guide processing according to the embodiment.

FIG. 5 is a view for describing a use state during the guide processing according to the embodiment.

### DETAILED DESCRIPTION

### Regarding One Embodiment

Hereinafter, an embodiment of an electric toothbrush will be described with reference to the drawings. In some cases, the drawings may be an enlarged view of components to facilitate understanding. In some cases, dimensional ratios of the components may be different from actual dimensional ratios or dimensional ratios in other drawings.

### (Overall Configuration)

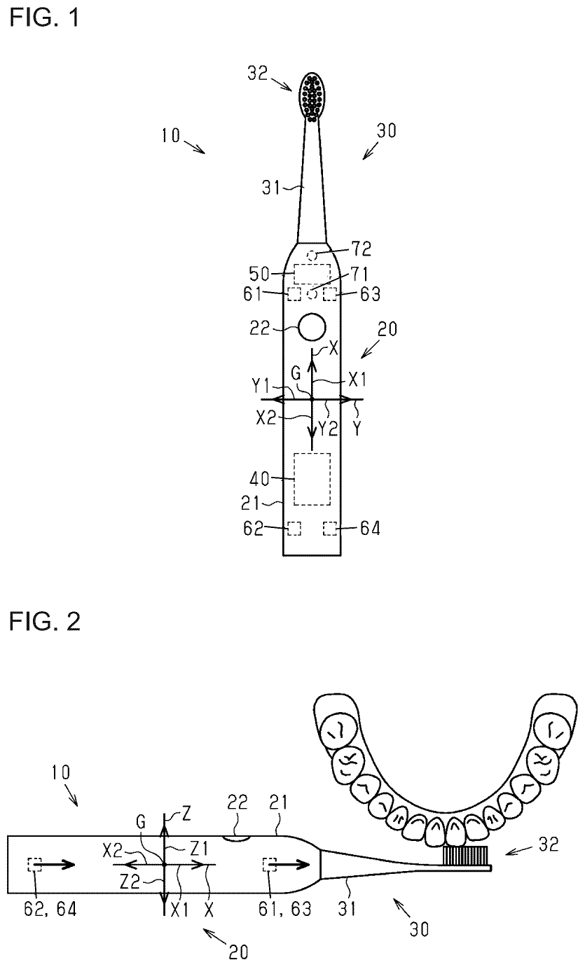

As illustrated in FIG. 1, an electric toothbrush 10 includes a handle 20, a head 30, and a control unit 40. The handle 20 includes a housing 21 that can be gripped by a user with fingers. The housing 21 has a cylindrical shape as a whole.

An axis passing through a center of gravity G of the housing 21 and extending in an extending direction of the housing 21 will be defined as a first reference axis X. In addition, one of axes passing through the center of gravity G of the housing 21 and orthogonal to the first reference axis X will be defined as a second reference axis Y. Furthermore, as illustrated in FIG. 2, another one of the axes passing through the center of gravity G of the housing 21 and orthogonal to the first reference axis X will be defined as a third reference axis Z. The third reference axis Z is an axis orthogonal to the second reference axis Y. One of directions along the first reference axis X will be defined as a first positive direction X1. A direction opposite to the first positive direction X1 of the directions along the first reference axis X will be defined as a first negative direction X2. In addition, as illustrated in FIG. 1, one of directions along the second reference axis Y will be defined as a second positive direction Y1. A direction opposite to the second positive direction Y1 of the directions along the second reference axis Y will be defined as a second negative direction Y2. Furthermore, as illustrated in FIG. 2, one of directions along the third reference axis Z will be defined as a third positive direction Z1. A direction opposite to the third positive direction Z1 of the directions along the third reference axis Z will be defined as a third negative direction Z2.

As illustrated in FIG. 1, the handle 20 includes a switch 22. When the switch 22 is operated by the user, a signal indicating an on- or off-state of power or a signal for selecting a control mode (to be described later) is input to the control unit 40. The switch 22 is located at the center of the housing 21 in the direction along the first reference axis X.

The head 30 includes a head main body 31 and a brush 32 for brushing teeth. The head main body 31 has a rod shape which is thinner than the housing 21 as a whole. The head main body 31 is connected to an end of the housing 21 on a side in the first positive direction X1. The head main body 31 extends along the first reference axis X. The brush 32 includes a plurality of bristles. The brush 32 is connected to an end portion of the head main body 31 on the side in the first positive direction X1. As illustrated in FIG. 2, each bristle in the brush 32 protrudes from the head main body 31 in the third positive direction Z1.

The head 30 is configured to be attachable to and detachable from the handle 20. In other words, the handle 20 is configured to be attachable to and detachable from the head 30. The user can keep the brush 32 in a clean state by regularly replacing the head 30.

The electric toothbrush 10 includes a driving body 50. The driving body 50 is located inside the housing 21. The driving body 50 is configured to vibrate the head main body 31. In this manner, the driving body 50 drives the brush 32 connected to the head main body 31. For example, the driving body 50 includes a motor and a weight eccentrically attached to a rotary shaft of the motor. The head main body 31 is connected to the weight.

The electric toothbrush 10 includes a first vibration body 61, a second vibration body 62, a third vibration body 63, and a fourth vibration body 64. The first vibration body 61 is located inside the housing 21. The first vibration body 61 has a cubic shape. Six planes forming an outer surface of the first vibration body 61 respectively face the first positive direction X1, the first negative direction X2, the second positive direction Y1, the second negative direction Y2, the third positive direction Z1, and the third negative direction Z2.

Although not illustrated, the first vibration body 61 includes a voice coil motor corresponding to each plane, a weight corresponding to each voice coil motor, and a cubic case that accommodates the voice coil motor and the weight. The weight vibrates due to a force generated in association with a current flow to a coil of the voice coil motor. When the weight vibrates, the case vibrates due to the vibration of the weight. Therefore, the current flowing to the coil of the voice coil motor is controlled, so that the first vibration body 61 vibrates in each of the direction along the first reference axis X, the direction along the second reference axis Y, and the direction along the third reference axis Z. More specifically, for example, the first vibration body 61 is a vibration body as described in Japanese Unexamined Patent Application Publication No. 2005-190465. A frequency of the vibration of the first vibration body 61 is significantly different from a frequency of the vibration of the driving body 50. Specifically, the vibration of the driving body 50 is a vibration in a frequency band much higher than the vibration of the first vibration body 61.

The first vibration body 61 is located on a virtual plane on which the first reference axis X and the second reference axis Y are present. In addition, the first vibration body 61 is located on a side in the first positive direction X1 and on a side in the second positive direction Y1 with respect to the center of gravity G of the housing 21.

The second vibration body 62 is located inside the housing 21. The second vibration body 62 is a vibration body similar to the first vibration body 61. The second vibration body 62 is located on a virtual plane on which the first reference axis X and the second reference axis Y are present. In addition, the second vibration body 62 is located on a side in the first negative direction X2 and on the side in the second positive direction Y1 with respect to the center of gravity G of the housing 21. The second vibration body 62 is located at a place line-symmetrical to the first vibration body 61 with respect to the second reference axis Y.

The third vibration body 63 is located inside the housing 21. The third vibration body 63 is a vibration body similar to the first vibration body 61. The third vibration body 63 is located on a virtual plane on which the first reference axis X and the second reference axis Y are present. In addition, the third vibration body 63 is located on the side in the first positive direction X1 and on a side in the second negative direction Y2 with respect to the center of gravity G of the housing 21. The third vibration body 63 is located at a place line-symmetrical to the first vibration body 61 with respect to the first reference axis X.

The fourth vibration body 64 is located inside the housing 21. The fourth vibration body 64 is a vibration body similar to the first vibration body 61. The fourth vibration body 64 is located on a virtual plane on which the first reference axis X and the second reference axis Y are present. In addition, the fourth vibration body 64 is located on the side in the first negative direction X2 and on the side in the second negative direction Y2 with respect to the center of gravity G of the housing 21. The fourth vibration body 64 is located at a place line-symmetrical to the second vibration body 62 with respect to the first reference axis X. In addition, the fourth vibration body 64 is located at a place line-symmetrical to the third vibration body 63 with respect to the second reference axis Y.

The electric toothbrush 10 includes an acceleration sensor 71 and a pressure sensor 72. The acceleration sensor 71 is a triaxial acceleration sensor. That is, the acceleration sensor 71 is a posture sensor that detects a posture of the handle 20 with respect to a gravity direction. Specifically, the acceleration sensor 71 stores in advance an orientation in the first negative direction X2 with respect to the acceleration sensor 71. The first negative direction X2 is a fixed direction determined by a shape of the housing 21. In addition, the first negative direction X2 with respect to the acceleration sensor 71 is also always a fixed direction. Next, on a plane including a straight line extending from the acceleration sensor 71 in the gravity direction and a straight line extending from the acceleration sensor 71 in the first negative direction X2, the acceleration sensor 71 specifies an angle formed by both the straight lines as a first inclination angle. Therefore, the acceleration sensor 71 sets the first inclination angle to 0 degrees when the gravity direction and the first negative direction X2 coincide with each other. In addition, the acceleration sensor 71 sets the first inclination angle to 180 degrees when the gravity direction and the first positive direction X1 coincide with each other. Similarly, on a plane including a straight line extending from the acceleration sensor 71 in the gravity direction and a straight line extending from the acceleration sensor 71 in the second negative direction Y2, the acceleration sensor 71 specifies an angle formed by both the straight lines as a second inclination angle. In addition, on a plane including a straight line extending from the acceleration sensor 71 in the gravity direction and a straight line extending from the acceleration sensor 71 in the third negative direction Z2, the acceleration sensor 71 specifies an angle formed by both the straight lines as a third inclination angle. In addition, the acceleration sensor 71 acquires the acceleration in the direction along each reference axis.

The pressure sensor 72 is located in the vicinity of an end of the housing 21 on the side in the first positive direction X1. The pressure sensor 72 detects a pressure received by the head 30 in the third negative direction Z2. That is, the pressure sensor 72 detects that the brush 32 is pressed against teeth of the user.

### (Regarding Control Unit)

The control unit 40 includes a CPU that performs various types of operations, and a ROM that stores a program executed by the CPU. The control unit 40 executes software processing. The control unit 40 acquires signals indicating the first inclination angle, the second inclination angle, and the third inclination angle from the acceleration sensor 71, and a signal indicating the acceleration in the direction along each reference axis. The control unit 40 acquires a signal indicating the pressure from the pressure sensor 72. The control unit 40 acquires various signals from the switch 22.

The control unit 40 acquires a signal indicating an on-state from the switch 22, and thereafter, calculates a movement direction and a movement amount from a place at which the signal indicating the on-state is acquired from the switch 22, based on the acceleration in the direction along each reference axis which is acquired from the acceleration sensor 71. In this manner, the control unit 40 calculates a current position of the handle 20 with the place at which the signal indicating the on-state is acquired from the switch 22, as a reference position. That is, the acceleration sensor 71 is also a position sensor that detects the position of the handle 20.

The control unit 40 controls the driving body 50. For example, the control unit 40 starts driving the driving body 50, when the signal indicating the on-state is acquired from the switch 22 and the switch 22 is further pressed once. In addition, for example, when the switch 22 is pressed long and a signal indicating an off-state is acquired from the switch 22, the control unit 40 stops driving the driving body 50.

The control unit 40 controls an operation of the first vibration body 61. The control unit 40 can cause the first vibration body 61 to generate a force sense by controlling a vibration pattern of the first vibration body 61. In the present embodiment, a direction of the force sense generated from the first vibration body 61 can be selected from any one of the first positive direction X1, the first negative direction X2, the second positive direction Y1, the second negative direction Y2, the third positive direction Z1, and the third negative direction Z2. Specifically, the control unit 40 controls a current flowing to each voice coil motor of the first vibration body 61. In this manner, the control unit 40 causes the first vibration body 61 to generate the vibration in which any one of the direction along the first reference axis X, the direction along the second reference axis Y, and the direction along the third reference axis Z is set as an amplitude direction. Furthermore, the control unit 40 causes the first vibration body 61 to generate a force sense in one direction or the other direction of such a reference axis by controlling the vibration pattern in the vibration in the direction along the reference axis. The force sense is a sense with regard to resistance received from an object. Therefore, for example, when the first vibration body 61 generates the force sense in the first positive direction X1, the user feels as if the first vibration body 61 is displaced in the first positive direction X1 even though the first vibration body 61 actually reciprocates and vibrates at the same position. Hereinafter, the force sense generated by the first vibration body 61 will be defined as a first force sense. In addition, a direction of the first force sense will be defined as a first direction.

Furthermore, the control unit 40 controls strength of the first force sense by controlling the vibration pattern of the first vibration body 61. For example, the control unit 40 increases the strength of the first force sense by increasing an overall amplitude after repeating the vibration in a predetermined period.

As in the first vibration body 61, the control unit 40 can cause the second vibration body 62 to generate the force sense by controlling the vibration pattern of the second vibration body 62. Hereinafter, the force sense generated by the second vibration body 62 will be defined as a second force sense. In addition, a direction of the second force sense will be defined as a second direction.

As in the first vibration body 61, the control unit 40 can cause the third vibration body 63 to generate the force sense by controlling the vibration pattern of the third vibration body 63. Hereinafter, the force sense generated by the third vibration body 63 will be defined as a third force sense. In addition, a direction of the third force sense will be defined as a third direction.

As in the first vibration body 61, the control unit 40 can cause the fourth vibration body 64 to generate the force sense by controlling the vibration pattern of the fourth vibration body 64. Hereinafter, the force sense generated by the fourth vibration body 64 will be defined as a fourth force sense. In addition, a direction of the fourth force sense will be defined as a fourth direction.

### (Regarding Guide Processing)

The control unit 40 executes guide processing by determining each of the first direction to the fourth direction in a specific direction. The guide processing is processing for providing the user with the force sense such that the handle 20 adopts a desired posture. The guide processing includes two types of processing, that is, first guide processing and second guide processing.

### (Regarding First Guide Processing)

For example, the control unit 40 starts the first guide processing, when the switch 22 is pressed once in a state where the driving body 50 is driven. In the control unit 40, it is assumed that the first reference axis X of the housing 21 is parallel to a left-right axis of the user when the first guide processing is started. In addition, in the control unit 40, it is assumed that the second reference axis Y of the housing 21 is parallel to an up-down axis of the user when the first guide processing is started. In the control unit 40, it is assumed that the third reference axis Z of the housing 21 is parallel to a front-rear axis of the user when the first guide processing is started. In this way, the control unit 40 executes the first guide processing on an assumption that the respective reference axes are parallel to the respective axes of the user. In addition, the control unit 40 stores a posture of the handle 20 when starting the first guide processing, as an initial posture. Furthermore, the control unit 40 stores a position of the brush 32 when starting the first guide processing, as an initial position.

In the first guide processing, the control unit 40 changes a target posture of the handle 20 and a target position of the brush 32 with time. Hereinafter, an example in which the electric toothbrush 10 guides an operation for brushing teeth from a front side surface of a front tooth to a front side surface of a back tooth on a left side will be described.

When the control unit 40 starts the first guide processing, the control unit 40 sets a first target posture of the housing 21 as an initial posture and sets a first target position of the brush 32 as an initial position for a fixed period. For example, the above-described fixed period is several seconds to several tens of seconds. Next, the control unit 40 changes the target posture of the handle 20 to a second target posture. Specifically, a posture in which the brush 32 rotates around the second reference axis Y such that the brush 32 faces the third positive direction Z1 with respect to the first target posture is set as the second target posture. A rotation angle around the second reference axis Y in this case is several degrees to several tens of degrees. The second reference axis Y of the housing 21 in the second target posture is parallel to the second reference axis Y of the housing 21 in the first target posture. In addition, the control unit 40 simultaneously changes the target position of the brush 32 to the second target position. Specifically, a place moved by 1 cm to the side in the first positive direction X1 with respect to the first target position and moved by 1 cm to the side in the third positive direction Z1 with respect to the first target position will be defined as the second target position. The control unit 40 maintains the second target posture and the second target position for a fixed period.

Thereafter, the control unit 40 changes the target posture of the handle 20 to a third target posture. A changing method from the second target posture to the third target posture is the same as a changing method from the first target posture to the second target posture. In addition, the control unit 40 simultaneously changes the target position of the brush 32 to a third target position. A changing method from the second target position to the third target position is the same as a changing method from the first target position to the second target position. The control unit 40 maintains the third target posture and the third target position for a fixed period.

Furthermore, the control unit 40 changes the target posture of the handle 20 to a fourth target posture. A changing method from the third target posture to the fourth target posture is the same as a changing method from the first target posture to the second target posture. In addition, the control unit 40 simultaneously changes the target position of the brush 32 to a fourth target position. A changing method from the third target position to the fourth target position is the same as a changing method from the first target position to the second target position. The control unit 40 maintains the fourth target posture and the fourth target position for a fixed period. Thereafter, the control unit 40 completes a series of first guide processing.

During the first guide processing described above, the control unit 40 controls the first direction to the fourth direction and the strength in the first force sense to the fourth force sense, in response to the posture of the handle 20 and the position of the brush 32 which are detected by the acceleration sensor 71.

Specifically, the control unit 40 compares the posture of the handle 20 which is detected by the acceleration sensor 71 with the target posture at that time point. When the posture of the handle 20 which is detected by the acceleration sensor 71 and the target posture at that time point do not coincide with each other, the control unit 40 generates the first force sense to the fourth force sense. The control unit 40 guides the posture in the order of the orientation of the first reference axis X, the orientation of the second reference axis Y, and the orientation of the third reference axis Z.

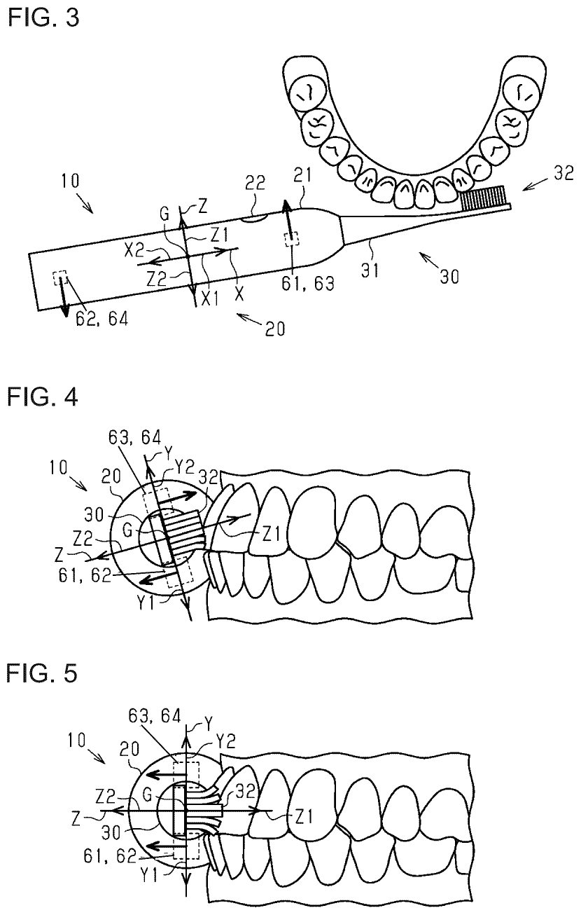

When the first reference axis X in the posture of the handle 20 which is detected by the acceleration sensor 71 is inclined with respect to the first reference axis X in the target posture, the control unit 40 generates the force sense as if the handle 20 rotates in a direction opposite to the inclination. Specifically, as illustrated in FIG. 3, it is assumed that the first reference axis X is inclined such that the brush 32 is located on the side in the third negative direction Z2 with respect to the target posture. In this case, the control unit 40 sets the first direction which is a direction of the first force sense generated by the first vibration body 61, as the third positive direction Z1, and sets the third direction which is a direction of the third force sense generated by the third vibration body 63, as the third positive direction Z1. Furthermore, the control unit 40 sets the second direction which is a direction of the second force sense generated by the second vibration body 62, as the third negative direction Z2, and sets the fourth direction which is a direction of the fourth force sense generated by the fourth vibration body 64, as the third negative direction Z2. In this manner, in FIG. 3, the user feels the force sense as if the handle 20 rotates counterclockwise around the second reference axis Y.

On the other hand, it is assumed that the first reference axis X in the posture of the handle 20 which is detected by the acceleration sensor 71 is inclined to a side opposite to a side in the example described above with respect to the first reference axis X in the target posture. In this case, the control unit 40 controls the direction of each force sense of the first vibration body 61 to the fourth vibration body 64 in the direction opposite to the direction in the example described above. In addition, the control unit 40 increases the strength of the first force sense to the fourth force sense, as the inclination angle of the first reference axis X increases in the posture of the handle 20 which is detected by the acceleration sensor 71 with respect to the first reference axis X in the target posture. The control unit 40 controls the first vibration body 61 to the fourth vibration body 64 such that magnitudes of the first force sense to the fourth force sense are equal to each other.

When the second reference axis Y in the posture of the handle 20 which is detected by the acceleration sensor 71 is inclined with respect to the second reference axis Y in the target posture, the control unit 40 generates the force sense as if the handle 20 rotates in a direction opposite to the inclination. Specifically, it is assumed that the second reference axis Y is inclined such that the brush 32 is located on the side in the second positive direction Y1 with respect to the target posture. In this case, the control unit 40 sets the first direction which is the direction of the first force sense generated by the first vibration body 61, as the second negative direction Y2, and sets the third direction which is the direction of the third force sense generated by the third vibration body 63, as the second negative direction Y2. Furthermore, the control unit 40 sets the second direction which is the direction of the second force sense generated by the second vibration body 62, as the second positive direction Y1, and sets the fourth direction which is the direction of the fourth force sense generated by the fourth vibration body 64, as the second positive direction Y1. In this manner, the user feels the force sense as if the handle 20 rotates around the third reference axis Z.

On the other hand, it is assumed that the second reference axis Y in the posture of the handle 20 which is detected by the acceleration sensor 71 is inclined to a side opposite to a side in the above-described example with respect to the second reference axis Y in the target posture. In this case, the control unit 40 controls the direction of each force sense of the first vibration body 61 to the fourth vibration body 64 in the direction opposite to the direction in the example described above. In addition, the control unit 40 increases the strength of the first force sense to the fourth force sense, as the inclination angle of the second reference axis Y increases in the posture of the handle 20 which is detected by the acceleration sensor 71 with respect to the second reference axis Y in the target posture. The control unit 40 controls the first vibration body 61 to the fourth vibration body 64 such that magnitudes of the first force sense to the fourth force sense are equal to each other.

When the third reference axis Z in the posture of the handle 20 which is detected by the acceleration sensor 71 is inclined with respect to the third reference axis Z in the target posture, the control unit 40 generates the force sense as if the handle 20 rotates in a direction opposite to the inclination. Specifically, as illustrated in FIG. 4, it is assumed that the third reference axis Z is inclined such that a bristle tip of the brush 32 faces a direction opposite to the gravity direction with respect to the target posture. In this case, the control unit 40 sets the first direction which is the direction of the first force sense generated by the first vibration body 61, as the third negative direction Z2, and sets the second direction which is the direction of the second force sense generated by the second vibration body 62, as the third negative direction Z2. Furthermore, the control unit 40 sets the third direction which is the direction of the third force sense generated by the third vibration body 63, as the third positive direction Z1, and sets a fourth direction which is the direction of the fourth force sense generated by the fourth vibration body 64, as the third positive direction Z1. In this manner, in FIG. 4, the user feels the force sense as if the handle 20 rotates clockwise around the first reference axis X.

On the other hand, it is assumed that the third reference axis Z in the posture of the handle 20 which is detected by the acceleration sensor 71 is inclined to a side opposite to a side in the above-described example with respect to the third reference axis Z in the target posture. In this case, the control unit 40 controls the direction of each force sense of the first vibration body 61 to the fourth vibration body 64 in the direction opposite to the direction in the example described above. In addition, the control unit 40 increases the strength of the first force sense to the fourth force sense, as the inclination angle of the third reference axis Z increases in the posture of the handle 20 which is detected by the acceleration sensor 71 with respect to the third reference axis Z in the target posture. The control unit 40 controls the first vibration body 61 to the fourth vibration body 64 such that magnitudes of the first force sense to the fourth force sense are equal to each other.

When the posture of the handle 20 coincides with the target posture at that time point, the control unit 40 compares the position of the brush 32 which is detected by the acceleration sensor 71 with the target position at that time point. When the position of the brush 32 which is detected by the acceleration sensor 71 and the target position at that time point do not coincide with each other, the control unit 40 generates the first force sense to the fourth force sense. The control unit 40 guides the position in the direction along the first reference axis X, the position in the direction along the second reference axis Y, and the position in the direction along the third reference axis Z in this order.

Furthermore, it is assumed that the posture of the handle 20 coincides with the target posture at that time point and the position of the brush 32 coincides with the target position at that time point during the first guide processing. In this case, the control unit 40 controls the first direction to the fourth direction and the strength of the first force sense to the fourth force sense, in response to the pressure received by the head 30. The control unit 40 stores a predetermined pressure range for the pressure received by the head 30. When the pressure received by the head 30 in the third negative direction Z2 deviates from the pressure range, the control unit 40 controls the first direction to the fourth direction and the strength of the first force sense to the fourth force sense such that the pressure received by the head 30 returns to the pressure range. The pressure range is determined as a range for realizing appropriate contact of the brush 32 with the teeth in brushing the teeth.

Specifically, as illustrated in FIG. 5, when the pressure received by the head 30 exceeds an upper limit value of the pressure range, the control unit 40 sets all of the first direction to the fourth direction to the third negative direction Z2. In this case, the control unit 40 increases the strength of the first force sense to the fourth force sense, as a difference increases between the pressure received by the head 30 and the upper limit value of the pressure range. In addition, when the pressure received by the head 30 falls below the lower limit value of the pressure range, the control unit 40 sets all of the first direction to the fourth direction to the third positive direction Z1. In this case, the control unit 40 increases the strength of the first force sense to the fourth force sense, as a difference increases between the pressure received by the head 30 and the lower limit value of the pressure range.

### (Regarding Second Guide Processing)

For example, the control unit 40 starts the second guide processing, when the switch 22 is pressed twice in a state where the driving body 50 is driven. In the second guide processing, unlike the first guide processing, the control unit 40 changes the first direction to the fourth direction in a predetermined order. Hereinafter, as in the first guide processing, an example of guiding an operation for brushing the teeth from a front side surface of a front tooth toward a front side surface of a back tooth on the left side will be described. As in the first guide processing, when the second guide processing starts, in the control unit 40, it is assumed that the first reference axis X of the housing 21 is parallel to the left-right axis of the user. In addition, when the second guide processing starts, in the control unit 40, it is assumed that the second reference axis Y of the housing 21 is parallel to the up-down axis of the user. When the second guide processing starts, in the control unit 40, it is assumed that the third reference axis Z of the housing 21 is parallel to the front-rear axis of the user. In this way, the control unit 40 executes the second guide processing on an assumption that each reference axis is parallel to each axis of the user.

Although not illustrated, the control unit 40 includes a storage unit which is a non-volatile memory. The storage unit stores an order of positions of the brush 32 which are changed in the second guide processing. For example, the order is determined in advance by a test, a simulation, or the like, as a suitable order of brushing the teeth from the front side surface of the front tooth to the front side surface of the back tooth on the left side.

In the second guide processing, first, the control unit 40 does not generate any of the first force sense to the fourth force sense for a fixed period. For example, the above-described fixed period is several seconds to several tens of seconds. Next, after the elapse of the fixed period, the control unit 40 generates the first force sense to the fourth force sense only for a first predetermined period as follows. The control unit 40 sets the first direction which is a direction of the first force sense generated by the first vibration body 61, as a third positive direction Z1, and sets the third direction which is a direction of the third force sense generated by the third vibration body 63, as the third positive direction Z1. Furthermore, the control unit 40 sets the second direction which is a direction of the second force sense generated by the second vibration body 62, as the third negative direction Z2, and sets the fourth direction which is a direction of the fourth force sense generated by the fourth vibration body 64, as the third negative direction Z2. In this manner, the user feels the force sense as if the handle 20 rotates around the second reference axis Y. The first predetermined period is set in advance as a period in which the user operates the handle 20 such that the posture of the handle 20 rotates from the first target posture to the second target posture by the first force sense to the fourth force sense.

Next, after the elapse of the first predetermined period, the control unit 40 sets the first direction to the fourth direction as the first positive direction X1, for only a second predetermined period. In this manner, the user feels the force sense as if the handle 20 straightly advances in the first positive direction X1. The second predetermined period is preset as a period in which the user operates the handle 20 such that the position of the handle 20 moves from the first target position to the second target position by the first force sense to the fourth force sense.

Next, after the elapse of the second predetermined period, the control unit 40 does not generate any of the first force sense to the fourth force sense for a fixed time. Next, after the elapse of the fixed period, the control unit 40 generates the first force sense to the fourth force sense only for a third predetermined period as follows. The control unit 40 sets the first direction which is a direction of the first force sense generated by the first vibration body 61, as a third positive direction Z1, and sets the third direction which is a direction of the third force sense generated by the third vibration body 63, as the third positive direction Z1. Furthermore, the control unit 40 sets the second direction which is a direction of the second force sense generated by the second vibration body 62, as the third negative direction Z2, and sets the fourth direction which is a direction of the fourth force sense generated by the fourth vibration body 64, as the third negative direction Z2. In this manner, the user feels the force sense as if the handle 20 rotates around the second reference axis Y. The above-described third predetermined period is preset as a period in which the user operates the handle 20 such that the posture of the handle 20 rotates from the second target posture to the third target posture by the first force sense to the fourth force sense.

Next, after the elapse of the third predetermined period, the control unit 40 sets the first direction to the fourth direction as the first positive direction X1 only, for a fourth predetermined period. In this manner, the user feels the force sense as if the handle 20 straightly advances in the first positive direction X1. The fourth predetermined period is set in advance as a period in which the user operates the handle 20 such that the position of the handle 20 moves from the second target position to the third target position by the first force sense to the fourth force sense.

Next, after the elapse of the fourth predetermined period, the control unit 40 does not generate any of the first force sense to the fourth force sense for a fixed time. Next, after the elapse of the fixed period, the control unit 40 generates the first force sense to the fourth force sense for a fifth predetermined period as follows. The control unit 40 sets the first direction which is a direction of the first force sense generated by the first vibration body 61, as a third positive direction Z1, and sets the third direction which is a direction of the third force sense generated by the third vibration body 63, as the third positive direction Z1. Furthermore, the control unit 40 sets the second direction which is a direction of the second force sense generated by the second vibration body 62, as the third negative direction Z2, and sets the fourth direction which is a direction of the fourth force sense generated by the fourth vibration body 64, as the third negative direction Z2. In this manner, the user feels the force sense as if the handle 20 rotates around the second reference axis Y. The above-described fifth predetermined period is set in advance as a period in which the user operates the handle 20 such that the posture of the handle 20 rotates from the third target posture to the fourth target posture by the first force sense to the fourth force sense.

Next, after the elapse of the fifth predetermined period, the control unit 40 sets the first direction to the fourth direction as the first positive direction X1, only for a sixth predetermined period. In this manner, the user feels the force sense as if the handle 20 straightly advances in the first positive direction X1. The sixth predetermined period is set in advance as a period in which the user operates the handle 20 such that the position of the handle 20 moves from the third target position to the fourth target position by the first force sense to the fourth force sense.

Next, after the elapse of the fourth predetermined period, the control unit 40 does not generate any of the first force sense to the fourth force sense for a fixed time. Thereafter, the control unit 40 completes a series of the second guide processing.

### Regarding Operation of Present Embodiment

When the first guide processing in the above-described embodiment is executed, and when the user changes the posture of the handle 20 in accordance with a change in the first target posture to the fourth target posture which are determined in advance, the user does not receive the presentation of the force sense relating to the posture from the electric toothbrush 10. On the other hand, when the operation of the handle 20 by the user cannot follow the first target posture to the fourth target posture which are changed with time, the force sense is presented from the electric toothbrush 10 to coincide with each target posture.

Similarly, when the user changes the posture of the brush 32 in accordance with the change in the first target position to the fourth target position which are determined in advance, the user does not receive the presentation of the force sense relating to the position from the electric toothbrush 10. On the other hand, when the operation of the handle 20 by the user cannot follow the first target position to the fourth target position which are changed with time, the force sense is presented from the electric toothbrush 10 to coincide with each target position.

When the second guide processing in the above-described embodiment is executed, the user receives the presentation of the force sense in a predetermined direction from the electric toothbrush 10. In addition, a direction of the force sense from the electric toothbrush 10 is changed in a predetermined order. Therefore, when the user adjusts the posture of the handle 20 and the position of the brush 32 in accordance with the direction of the presented force sense, the operation preset in the electric toothbrush 10 can be reproduced.

### Effect of Present Embodiment

(1) According to the embodiment described above, in the first guide processing, the control unit 40 controls the first direction to the fourth direction, in response to the posture of the handle 20 which is detected by the acceleration sensor 71 as the posture sensor. Therefore, the first guide processing can present the force sense to the user such that the posture of the handle 20 is guided to the suitable posture. That is, the electric toothbrush 10 can guide the user who uses the electric toothbrush 10 to adopt a suitable moving method.

(2) According to the embodiment described above, in the first guide processing, the control unit 40 controls each strength of the first force sense to the fourth force sense, in response to the posture of the handle 20 which is detected by the acceleration sensor 71 as the posture sensor. Therefore, in the first guide processing, the strength of the force sense can be adjusted for the user such that the posture of the handle 20 is guided to a suitable posture. Therefore, as the user operates the posture of the handle 20 with a less suitable posture, the user can be guided to adopt a suitable moving method by the strong force sense.

(3) According to the embodiment described above, in the first guide processing, the control unit 40 controls the first direction to the fourth direction, in response to the position of the brush 32 which is detected by the acceleration sensor 71 as the position sensor. Therefore, the first guide processing can present the force sense to the user such that the position of the brush 32 is guided to a suitable position. That is, the electric toothbrush 10 can guide the user who uses the electric toothbrush 10 to adopt a suitable moving method.

(4) According to the embodiment described above, in the first guide processing, the control unit 40 controls each strength of the first force sense to the fourth force sense, in response to the position of the brush 32 which is detected by the acceleration sensor 71 as the position sensor. Therefore, in the first guide processing, the strength of the force sense can be adjusted for the user such that the position of the brush 32 is guided to a suitable posture. Therefore, as the user operates the position of the brush 32 with a less suitable position, the user can be guided to adopt a suitable moving method by the strong force sense.

(5) The desired posture of the electric toothbrush 10 may vary depending on whether the position of the tooth to be brushed is located on the front tooth side or on the back tooth side. According to the embodiment described above, the control unit 40 changes the target posture of the handle 20 and the target position of the brush 32 with time. Therefore, the target posture of the handle 20 can be guided to a posture corresponding to the position of the tooth to be brushed.

(6) According to the embodiment described above, in the guide processing, the control unit 40 can control the vibration pattern of each vibration body such that all of the first direction to the fourth direction are the same direction. Therefore, in this guide processing, the user can be provided with the force sense as if the handle 20 straightly advances. Therefore, the user can be guided that the user is in a situation where the electric toothbrush 10 needs to straightly advance.

(7) According to the embodiment described above, the control unit 40 can perform control in the guide processing such that the second direction is opposite to the first direction. In this case, the control unit 40 can perform control in the guide processing such that a virtual straight line extending from the first vibration body 61 in the first direction and a virtual straight line extending from the second vibration body 62 in the second direction are not located on the same straight line. Therefore, in this guide processing, the user can be provided with the force sense as if the handle 20 rotates. Therefore, the user can be guided that the user is in a situation where the electric toothbrush 10 needs to move to rotate.

(8) According to the embodiment described above, the control unit 40 controls the second guide processing by changing the first direction to the fourth direction in a predetermined order. This guide processing can present the force sense to the user such that a suitable change in the posture of the handle 20 is reproduced. That is, the user can reproduce a suitable moving method for the electric toothbrush 10 by changing the posture of the handle 20 in accordance with the force sense presented by the electric toothbrush 10.

### OTHER EMBODIMENTS

The embodiment described above can be modified and implemented as follows. The embodiment described above and the following modification examples can be combined and implemented within a scope in which the embodiment and the modification example do not technically contradict each other.

The shape of the housing 21 of the handle 20 may be appropriately changed. For example, a portion may be recessed to be easily gripped by the user with the fingers, and the dimension in the direction along the third reference axis Z may be larger than the dimension in the direction along the second reference axis Y.

The shape of the brush 32 may be appropriately changed. For example, a configuration may be adopted such that a plurality of bristles extend from the head main body 31 not only in the third positive direction Z1 but also in the third negative direction Z2, the second positive direction Y1, and the second negative direction Y2.

The driving body 50 is not limited to a case where the brush 32 is driven by vibrating the head main body 31, and may directly drive the brush 32. In addition, the driving body 50 may be located in the head main body 31.

In the embodiment described above, the control unit 40 is not limited to a case including the CPU and the ROM to execute software processing. For example, the control unit 40 may include a dedicated hardware circuit (for example, an ASIC or the like) that performs hardware processing on at least a portion of the software processing in each of the above-described embodiments. That is, the control unit 40 may have any of configurations (a) to (c) below. (a) a configuration including a processing unit which executes all of the above-described processing in accordance with a program, and a program storage unit such as the ROM that stores the program. (b) a configuration including a processing unit and a program storage unit which execute a portion of the above-described processing in accordance with a program, and a dedicated hardware circuit which executes the remaining processing. (c) a configuration including a dedicated hardware circuit which executes all of the above-described processing. Here, a plurality of the software execution units including the processing unit and the program storage unit, or a plurality of the dedicated hardware circuits may be provided. In addition, the storage unit provided in the control unit 40 may be the ROM which stores the program executed by the CPU or the like, or may be provided separately from the ROM.

As the guide processing, a configuration may be adopted such that the control unit 40 can execute one or more processing selected from the first guide processing and the second guide processing. That is, a configuration may be adopted such that the control unit 40 cannot execute the first guide processing or the second guide processing.

In the guide processing, a configuration may be adopted such that the control unit 40 does not control all of the first direction to the fourth direction. In the guide processing, the control unit 40 may control one or more directions selected from the first direction to the fourth direction.

In the embodiment described above, as the first guide processing, an example of guiding an operation for brushing teeth from a front side surface of a front tooth to a front side surface of a back tooth on a left side has been described. The operation may be an operation for brushing teeth from the front side surface of the back tooth to the front side surface of the front tooth, an operation for brushing a back side surface of the tooth, or any other operation. Various operations can be guided as long as a target posture of the handle 20 and a change thereof, and a target position of the brush 32 and a change thereof can be determined in advance.

In the first guide processing, the control unit 40 may control the first to fourth directions, in response to the posture of the handle 20 or the position of the brush 32. For example, a configuration may be adopted such that the control unit 40 does not control the first direction to the fourth direction, in response to the position of the brush 32. That is, in the first guide processing, the control unit 40 may control the handle 20 such that the posture of the handle 20 coincides with the target posture. In this case, a configuration may be adopted such that the control unit 40 does not calculate the position of the brush 32. In addition, for example, a configuration may be adopted such that the control unit 40 does not control the first direction to the fourth direction, in response to the posture of the handle 20. That is, in the first guide processing, the control unit 40 may control the brush 32 such that the position of the brush 32 coincides with the target position. In this case, a configuration may be adopted such that the control unit 40 does not detect the posture of the handle 20.

A configuration may be adopted such that the control unit 40 does not control the strength of the first force sense to the fourth force sense, in response to the posture of the handle 20. For example, the control unit 40 may control the strength of the first force sense to the fourth force sense to be constant, regardless of a magnitude of a difference between the posture of the handle 20 and the target posture.

In the first guide processing, the control unit 40 may provide the user with the force sense as if the handle 20 rotates by the first force sense and the second force sense, and may simultaneously provide the user with the force sense as if the handle 20 straightly advances by the third force sense and the fourth force sense. Specifically, the control unit 40 sets the first direction which is a direction of the first force sense generated by the first vibration body 61, as the third positive direction Z1, and sets the second direction which is a direction of the second force sense generated by the second vibration body 62, as the third negative direction Z2. Simultaneously, the control unit 40 sets the third direction which is a direction of the third force sense generated by the third vibration body 63, and the fourth direction which is a direction of the fourth force sense generated by the fourth vibration body 64, as the first positive direction X1 which is different from both the first direction and the second direction. In this case, the user feels the force sense as if the handle 20 straightly advances and moves in the first positive direction X1 while rotating around the second reference axis Y. In a case of this modification example, the control unit 40 can simultaneously execute processing for causing the posture of the handle 20 to coincide with the target posture and processing for causing the position of the brush 32 to coincide with the target position.

In the first guide processing, the control unit 40 may always maintain the same target posture. Similarly, in the first guide processing, the control unit 40 may always maintain the same target position. For example, during the first guide processing, the control unit 40 may set the target posture of the handle 20 to an initial posture, and may set the target position of the brush 32 to an initial position. In this case, the teeth in contact with the brush 32 when the first guide processing starts can be intensively brushed.

The control unit 40 may include a mode for storing an order of the first direction to the fourth direction to be presented in the second guide processing. For example, in this case, the user first operates the handle 20 with a suitable operation which the user wants to store in the control unit 40, during a period in which the control unit 40 executes a mode for storing the order of the first direction to the fourth direction. Next, the control unit 40 causes the storage unit to sequentially store time-series data of the posture of the handle 20 and the position of the brush 32 during the period. In the second guide processing, the control unit 40 changes the first direction to the fourth direction to reproduce the time-series data relating to the stored posture of the handle 20 and the stored position of the brush 32 in the second guide processing.

The configuration of each vibration body is not limited to the configuration of the embodiment described above. For example, the first vibration body 61 may be a vibration body using vibration of a motor, or may be a vibration body having a piezoelectric element. In addition, a configuration may be adopted such that the force sense is not generated in all directions along the three reference axes. For example, a configuration may be adopted such that the first direction can be controlled only in the direction along the first reference axis X, the second direction can be controlled only in the direction along the second reference axis Y, and the third direction can be controlled only in the direction along the third reference axis Z.

The third vibration body 63 and the fourth vibration body 64 may be omitted. The number of the vibration bodies provided in the electric toothbrush 10 may be at least two, may be three, or may be five or more.

The position of each vibration body is not limited to the example of the embodiment described above. For example, the fourth vibration body 64 may be located to coincide with the center of gravity G, or does not need to be located on a virtual plane on which the first vibration body 61 to the third vibration body 63 are present.

The pressure sensor 72 may be omitted. In this case, in the first guide processing, the control unit 40 may omit the control of the first vibration body 61 to the fourth vibration body 64 in response to the pressure received by the head 30.

The position sensor is not limited to the acceleration sensor 71. The position sensor may be a sensor that can detect the position of the brush 32. For example, the position of the brush 32 may be detected, based on an image captured by a video camera. In this case, the video camera functions as the position sensor.

Similarly, the posture sensor is not limited to the acceleration sensor 71. As in the modification example described above, the posture of the handle 20 may be detected, based on the image captured by the video camera. In this case, the video camera functions as the posture sensor.

In addition, for example, two transmission sensors and a reception sensor may be used as the position sensor and the posture sensor. In this case, for example, since time-series data of transmission positions of the two transmission sensors is acquired, the control unit 40 can detect the posture of the handle 20 and the position of the brush 32 from a change in the transmission positions of the two transmission sensors.

The electric toothbrush 10 may further include a camera that can detect dirt adhering to the teeth. In this case, the control unit 40 may execute the first guide processing by using the position of the dirt on the teeth which is detected by the camera as the target position.

### REFERENCE SIGNS LIST

10 electric toothbrush
20 handle
30 head
32 brush
40 control unit
50 driving body
61 first vibration body
62 second vibration body
63 third vibration body
64 fourth vibration body
71 acceleration sensor
72 pressure sensor

1. An electric toothbrush comprising:
a handle configured to be gripped by a user with fingers;
a first vibrator inside the handle;
a second vibrator inside the handle;
a head coupled to the handle and comprising a brush;
a driver configured to drive the brush;
a controller configured to cause the first vibrator to generate a first force sense in a first direction by controlling a vibration pattern of the first vibrator, and configured to cause the second vibrator to generate a second force sense in a second direction by controlling a vibration pattern of the second vibrator; and
a posture sensor configured to detect a posture of the handle,
wherein the controller is configured to control the first and second vibrators based on the posture of the handle detected by the posture sensor.

2. The electric toothbrush according to claim 1,
wherein the controller is configured to control a strength of the first force sense and a strength of the second force sense based on the posture of the handle detected by the posture sensor.

3. An electric toothbrush comprising:
a handle configured to be gripped by a user with fingers;
a first vibrator inside the handle;
a vibrator inside the handle;
a head coupled to the handle and comprising a brush;
a driver configured to drive the brush;
a controller configured to cause the first vibrator to generate a first force sense in a first direction by controlling a vibration pattern of the first vibrator, and configured to cause the second vibrator to generate a second force sense in a second direction by controlling a vibration pattern of the second vibrator; and
a position sensor configured to detect a position of the brush,
wherein the controller is configured to control the first and second vibrators based on the position of the brush detected by the position sensor.

4. The electric toothbrush according to claim 1, further comprising:
a position sensor configured to detect a position of the brush,
wherein the controller is configured to control the first and second vibrators based on the position of the brush detected by the position sensor.

5. The electric toothbrush according to claim 3,
wherein the controller is configured to control a strength of the first force sense and a strength of the second force sense based on the position of the brush detected by the position sensor.

6. The electric toothbrush according to claim 1,
wherein the controller is configured to control the vibration pattern of the first vibrator and the vibration pattern of the second vibrator such that the second direction is a same direction as the first direction.

7. The electric toothbrush according to claim 3,
wherein the controller is configured to control the vibration pattern of the first vibrator and the vibration pattern of the second vibrator such that the second direction is a same direction as the first direction.

8. The electric toothbrush according to claim 1,
wherein the controller is configured to control the vibration pattern of the first vibrator and the vibration pattern of the second vibrator such that the second direction is opposite to the first direction, and such that a virtual straight line extending from the first vibrator in the first direction and a virtual straight line extending from the second vibrator in the second direction are not the same.

9. The electric toothbrush according to claim 3,
wherein the controller is configured to control the vibration pattern of the first vibrator and the vibration pattern of the second vibrator such that the second direction is opposite to the first direction, and such that a virtual straight line extending from the first vibrator in the first direction and a virtual straight line extending from the second vibrator in the second direction are not the same.

10. The electric toothbrush according to claim 1, further comprising:
a third vibrator inside the handle.

11. The electric toothbrush according to claim 3, further comprising:
a third vibrator inside the handle.

12. An electric toothbrush comprising:
a handle configured to be gripped by a user with fingers;
a first vibrator inside the handle;
a second vibrator inside the handle;
a head coupled to the handle and comprising a brush;
a driver configured to drive the brush; and
a controller configured to cause the first vibrator to generate a first force sense in a first direction by controlling a vibration pattern of the first vibrator, and configured to cause the second vibrator to generate a second force sense in a second direction by controlling a vibration pattern of the second vibrator,
wherein the controller comprises memory that stores a predetermined order for changing from the first direction and the second direction, and
wherein the controller is configured to change control of the first and second vibrators in the predetermined order.
